(19) United States
(12) Patent Application Publication
(10) Pub. No.: US 2013/0191079 A1
(43) Pub. Date: Jul. 25, 2013

(54) POROUS BLOCKER BAR FOR PLATE-FIN HEAT EXCHANGER

(71) Applicants: DAVID BERUKHIM, LOS ANGELES, CA (US); ANDREW LEISHMAN, LONG BEACH, CA (US); VAHE AVANESSIAN, PACIFIC PALISADES, CA (US)

(72) Inventors: DAVID BERUKHIM, LOS ANGELES, CA (US); ANDREW LEISHMAN, LONG BEACH, CA (US); VAHE AVANESSIAN, PACIFIC PALISADES, CA (US)

(73) Assignee: HONEYWELL INTERNATIONAL INC., MORRISTOWN, NJ (US)

(21) Appl. No.: 13/356,525

(22) Filed: Jan. 23, 2012

(51) Int. Cl. G06F 17/50; F28F 1/00; F28D 7/00

(52) U.S. Cl. 703/1; 165/165; 165/177

(57) ABSTRACT

A plate-fin heat exchanger adapted to reduce thermal fatigue is described. The plate-fin heat exchanger includes a cold fluid pathway running along a first axis, a hot fluid pathway running along a second axis perpendicular to the first axis, and at least one porous blocker bar running along the first axis. The porous blocker bar includes a set of pores adapted to control the flow along the hot fluid pathway and coupled to an inlet of the hot fluid pathway.

### BACKGROUND AND SUMMARY OF THE INVENTION

The present invention generally relates to high-temperature plate-fin heat exchangers. Such heat exchangers may include a cold fluid pathway and a hot fluid pathway. The heat exchanger may be used to heat cold fluid (e.g., outside air) and/or cool hot fluid (e.g., cooling fluid from an engine). Plate-fin heat exchangers may operate with any combination of fluids (gas, liquid, or two-phase fluid). The hot fluid may include transient changes in temperature due to various operating conditions (e.g., increased heat from engine throttling).

Such transient changes in temperature create gradients throughout the heat exchanger that may cause degraded performance and/or operating life due to thermal fatigue of tube sheets with the heat exchanger. High-temperature heat exchangers may be especially susceptible to fatigue at the hot/hot corner (the corner at the hot inlet and cold outlet) and the hot/cold corner (the corner at the hot inlet and the cold inlet).

Accordingly, there is a need for a heat exchanger with improved resistance to thermal fatigue.

In one aspect of the present invention, a plate-fin heat exchanger adapted to reduce thermal fatigue, includes a cold fluid pathway running along a first axis, a hot fluid pathway running along a second axis perpendicular to the first axis, and at least one porous blocker bar running along the first axis, where the porous blocker bar includes a set of pores adapted to control flow along the hot fluid pathway and coupled to an inlet of the hot fluid pathway.

In another aspect of the present invention, a porous blocker bar adapted for use in a plate-fin heat exchanger includes a front face, a rear face, and multiple pores, each of the pores spanning from the front face to the rear face.

In yet another aspect of the present invention, a method of configuring a porous blocker bar for use in a plate-fin heat exchanger includes: receiving dimensional parameters, evaluating the received parameters, calculating design parameters at least partly based on the received parameters, and storing the calculated design parameters.

These and other features, aspects and advantages of the present invention will become better understood with reference to the following drawings, description and claims.

### BRIEF DESCRIPTION OF THE DRAWINGS

FIG. 1 illustrates a perspective view of a section of a plate-fin heat exchanger;

FIG. 2 illustrates a perspective view of a section of a plate-fin heat exchanger including a porous blocker bar according to an exemplary embodiment of the present invention;

FIG. 3 illustrates a detailed perspective view of the porous blocker bar of FIG. 2;

FIG. 4 illustrates a top view of a section of the porous blocker bar of FIG. 2, specifically highlighting the size and spacing of pores along the porous blocker bar;

FIG. 5 illustrates a flow chart of a conceptual process used in some embodiments to configure various physical parameters of the porous blocker bar of FIG. 2; and

FIG. 6 illustrates a schematic diagram of a conceptual system used in some embodiments to implement the process of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. Broadly, embodiments of the present invention generally provide a way to reduce fatigue experienced by components of a heat exchanger and improve temperature gradients within the heat exchanger. The porous blocker bars of the present invention may be configured such that structural integrity of the heat exchanger may be improved and hot flow may be reduced and/or dampened. In this manner, the operating life and performance of the heat exchanger may be improved.

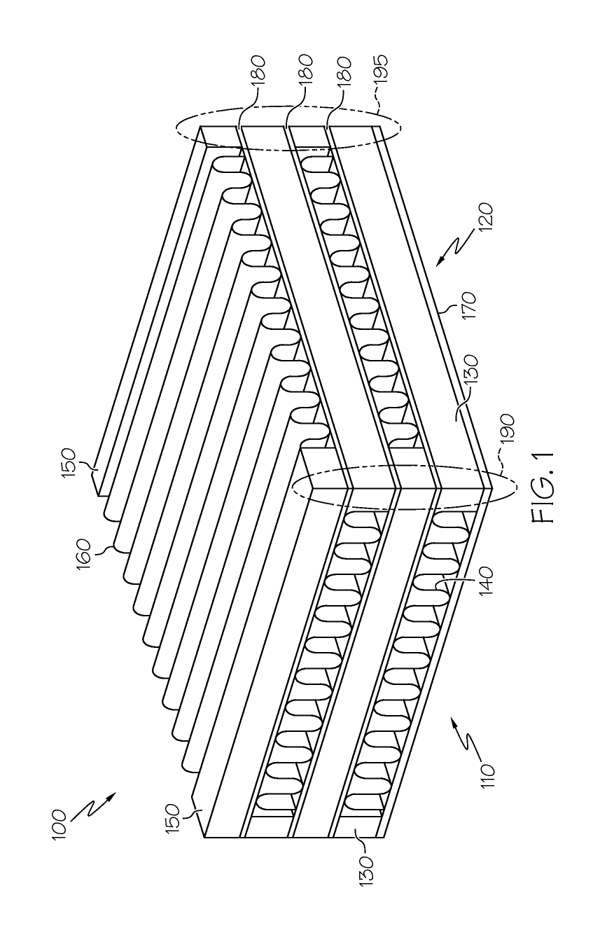

FIG. 1 illustrates a perspective view of a section of a plate-fin heat exchanger 100. Specifically, this figure shows the various components of the heat exchanger 100, which may include a cold fluid pathway 110, a hot fluid pathway 120, cold bars 130, cold fins 140, hot bars 150, hot fins 160, side plate 170, and/or tube sheets 180. In addition, FIG. 1 shows the hot-cold corner 190 and the hot-hot corner 195 of the heat exchanger 100. Such a heat exchanger may further include a second side plate (omitted for clarity) at the opposite side of the heat exchanger 100 from the first side plate 170.

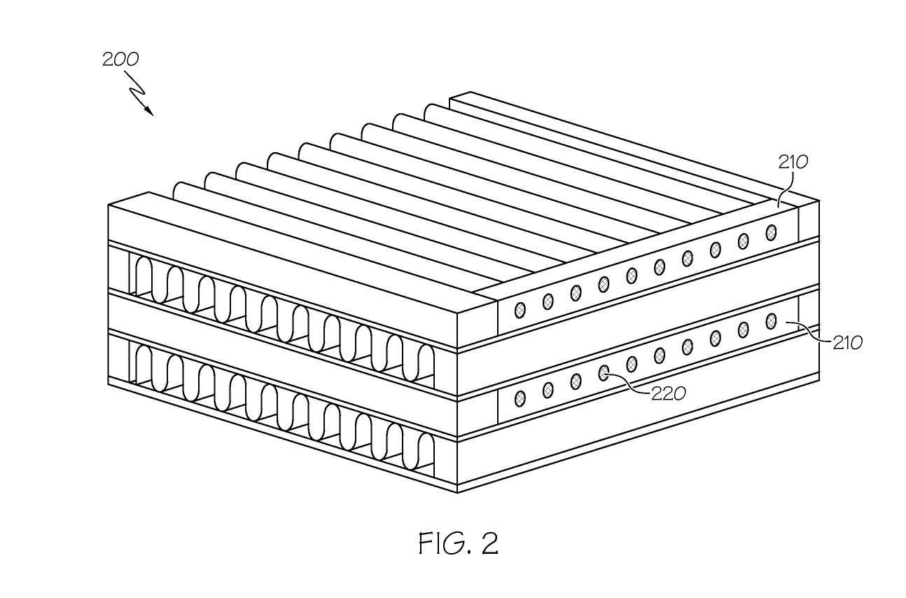

FIG. 2 illustrates a perspective view of a section of a plate-fin heat exchanger 200 including porous blocker bars 210 according to an exemplary embodiment of the present invention. The blocker bars may be placed at each inlet and/or outlet to each flow passageway.

Such porous blocker bars may provide improved structural integrity, reinforcing the tube sheets 180 and more evenly distributing loads across the passage width of the hot inlet face. In addition, the blocker bars may reduce global and local temperature gradients within the passages of the heat exchanger by increasing local capacitance, thus slowing down metal temperature reaction rates in critical areas. The temperature gradients may also be improved by restricting the amount of hot fluid flow that can enter the passages.

As shown in FIG. 2, each porous blocker bar 210 may include multiple “pores” 220 (i.e., enclosed passageways that may allow fluid to flow through the porous blocker bar). The pores 220 may be round through-holes oriented along one axis of the blocker bar 210. In some embodiments, the heat exchanger 200 may be sealed and connected in such a way that the operating parameters of the hot fluid pathway 120 may be determined by the pores 220. In this manner, the pores may be used to control hot flow through the heat exchanger (e.g., by configuring the pores to have an appropriate size and/or spacing for the desired flow). The porous blocker bars 210 and/or the pores 220 may utilize application-specific configurations, as described in more detail below.

The cold fluid pathway 110 may allow cold fluid to pass through the heat exchanger 200 in a first direction (indicated by arrow 110). The cold bars 130 may be arranged such that the bars seal the edges of the cold fluid pathway 110 along the direction of flow. The cold fins 140 may be arranged such that the fins allow fluid to flow along the cold fluid pathway 110. The hot fluid pathway 120 may allow hot fluid to pass through the heat exchanger in a second direction (indicated by arrow 120). The hot bars 150 may be arranged such that the bars seal the edges of the hot fluid pathway 120 along the direction of flow. The hot fins 160 may be arranged such that the fins allow fluid to flow along the hot fluid pathway 120. The side plate (or plates) 170 and tube sheets 180 may be arranged such that the pathways 110-120 each allow flow along a single axis. Each fluid pathway may include a number of flow passages (i.e., flow paths at each level of the pathway).

Although the pores 220 are represented as round through-holes in the example of FIG. 2, one of ordinary skill in the art will recognize that different embodiments may include different pores, as appropriate. For example, some embodiments may include pores that have non-round shapes (e.g., square, triangular, octagonal, etc.) or are otherwise irregularly-shaped (e.g., ellipses, non-symmetrical polygons, etc.). In addition, some embodiments may include different pores (e.g., a single embodiment may include round and non-round pores). Furthermore, some embodiments may include non-uniformly sized pores (e.g., the pores may be sized to be smaller at the ends of the blocker bar and larger near the center of the blocker bar, or vice-versa).

The various components of the heat exchanger 200 may be made from various appropriate materials (e.g., steel, aluminum, titanium, etc.) and/or combinations of materials. In addition, the heat exchanger may include different numbers of various components, as appropriate (e.g., based on the size of the heat exchanger, operating temperatures, flow requirements, etc.). Such components may be arranged in various appropriate ways. For example, different embodiments may include different numbers of flow passages. As another example, different embodiments may include different numbers of hot and/or cold bars (and interceding hot and/or cold fins) at each passage.

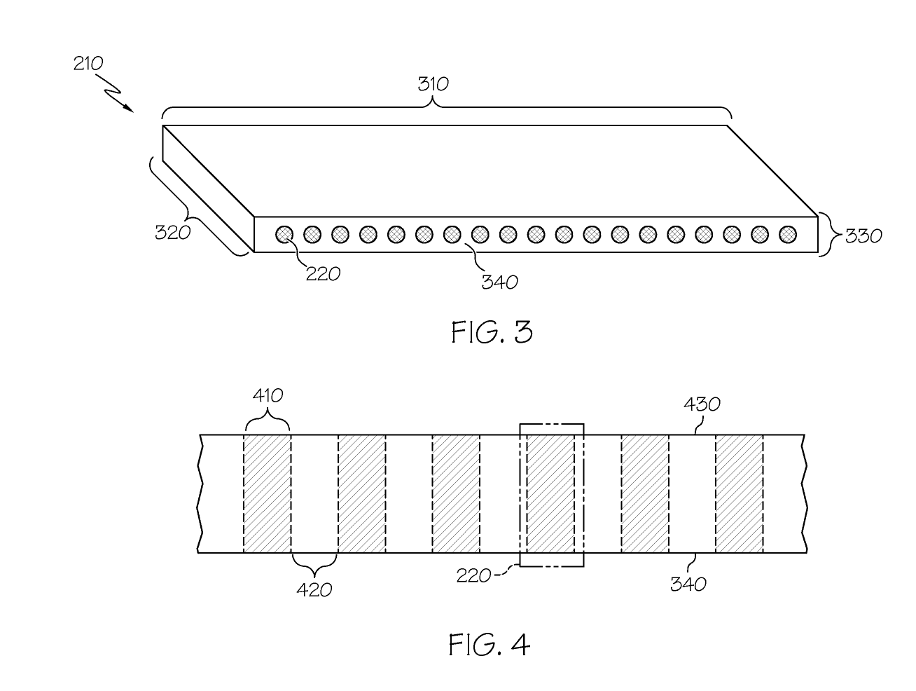

FIG. 3 illustrates a perspective view of the porous blocker bar 210. As shown, in some embodiments, the blocker bar may have a generally rectangular shape, where the shape may be defined by a width 310, depth 320, and height 330. Different embodiments may utilize different blocker bars, as appropriate (e.g., bars of varying size, shape, etc.). The pores 220 may run from a front face 340 of the blocker bar to a rear face. The front face may be situated to face toward the direction of the hot fluid pathway 120 (i.e., the inlet end of the pathway) while the rear face may be situated to face toward the outlet end of the pathway. In this example, the pores are arranged at constant spacing along the middle of the front face 340, however, the pores may be arranged in various appropriate ways (e.g., a grid of offset pores, sets of pores at various locations along the face, etc.).

FIG. 4 illustrates a top view of a section of the porous blocker bar 210, specifically highlighting the size 410 and spacing 420 of pores 220 along the porous blocker bar. In this example, the pores run from the front face 340 to the rear face 430. The size 410 of the pores 220 is defined by a diameter of the through-hole, while the spacing 420 is defined by a distance along a second axis of the blocker bar. Although the pores 220 are shown in this example as having a constant diameter through the entire depth 320 of the blocker bar 210, different embodiments may have differently-shaped pores (e.g., the pores may taper from a larger diameter at the inlet side of the blocker bar to a smaller diameter at the outlet side of the blocker bar, or vice-versa).

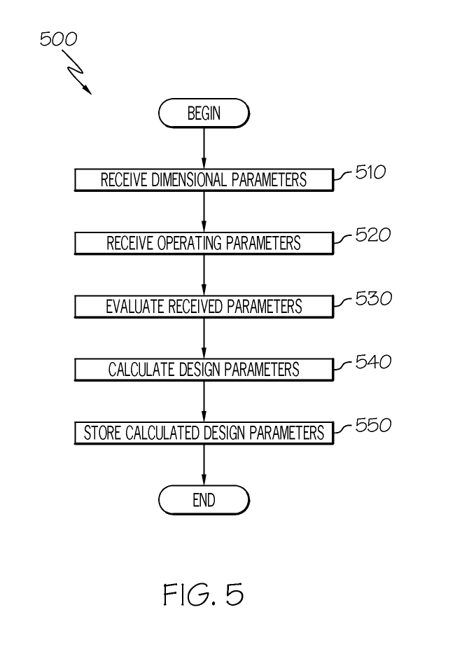

FIG. 5 illustrates a flow chart of a conceptual process 500 used in some embodiments to configure various physical parameters of the porous blocker bar 210. Such application-specific configurations may allow the porous blocker bars to be optimized for use in a variety of heat exchangers that may correspond to a variety of applications. The process may be performed by a system such as the system 600 described below.

Process 500 may begin when a user begins design of a porous blocker bar. As shown, the process may receive (at 510) dimensional parameters. Such dimensional parameters may include the size and/or shape of the blocker bar, desired pore size, etc. Next, the process may receive (at 520) various operating parameters for the blocker bar. Such operating parameters may include minimum and/or maximum flow rates, operating temperatures, etc. In addition, the operating parameters may include various user-desired performance of the heat exchanger (e.g., temperature gradients, heat exchange, operating life, etc.).

The process may then evaluate (at 530) the parameters received at 510 and 520. Such evaluation may include comparing the received parameters to various thresholds or tolerances, any limitations of the manufacturing facility, etc. The process may then calculate (at 540) various design parameters. Such calculation may involve performing a set of mathematical operations, optimizing results for a particular manufacturing facility, etc. The design parameters may include the size, shape, and/or spacing of pores to be included in the blocker bar. Finally, the process may store (at 550) the calculated design parameters and then end. The stored design parameters may then be available for use in designing and manufacturing the blocker bars.

Although process 500 has been described with reference to various details, one of ordinary skill in the art will recognize that the process may be performed in various appropriate ways without departing from the spirit of the invention. For instance, the operations of the process may be performed in various different orders. As another example, only a subset of operations may be performed in some embodiments, or the process may be performed as a set of sub-processes. As yet another example, the process may be performed as a sub-process of another process.

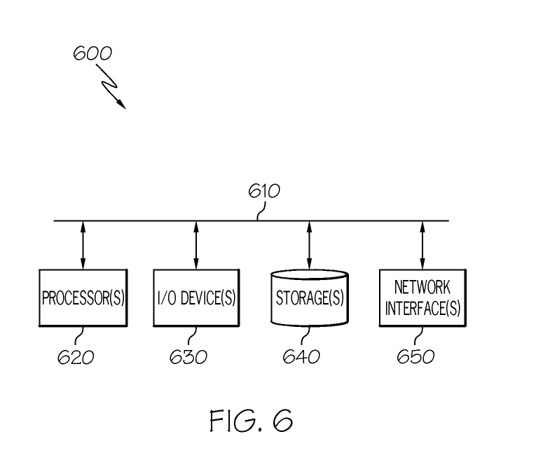

FIG. 6 illustrates a schematic diagram of a conceptual system 600 used in some embodiments to implement process 500. As shown, the system 600 may include a bus 610, one or more processors 620, one or more input/output devices 630, one or more storages 640, and/or one or more network interface(s). The system may be implemented using a variety of specific devices, either alone or in conjunction (e.g., a mobile device, a personal computer, a tablet device, a Smartphone, a server, etc.) and/or a variety of communication pathways, either alone or in conjunction (e.g., physical pathways such as wires and cables, wireless pathways, etc.).

The bus 610 conceptually represents all communication pathways available to the system 600. The processor(s) 620 may include various computing devices (e.g., microprocessors, digital signal processors, application-specific integrated circuits, etc.). The input/output device(s) 630 may include input devices such as mice, keyboards, etc., and/or output devices such as monitors, printers, etc. The storage(s) 640 may include various transitory and/or non-transitory storage(s) (e.g., RAM storage, ROM storage, “cloud” storage, etc.). The network interface(s) 650 may include various circuitry and/or software that allow the system 600 to connect to one or more networks (e.g., a local-area network, a wide-area network, etc.) or one or more networks of networks (e.g., the Internet).

System 600 may be used to execute the operations of, for instance, process 500. In some embodiments, process 500 may be implemented using sets of software instructions. Such sets of software instructions may be stored in storage 640 such that they may be retrieved and executed by processor 620. In addition, data such as dimensional parameters and/or operating parameters may be stored in storage 640. Processor 620 may retrieve and use the data when executing the software instructions to evaluate the received parameters and calculate the design parameters. The processor 620 may send the calculated design parameters to the storage 640. In this manner, the calculated design parameters may be made available to various appropriate manufacturing entities (e.g., the design parameters may be used to generate technical drawings that are supplied to a machine shop that will fabricate the porous blocker bars).

It should be understood, of course, that the foregoing relates to exemplary embodiments of the invention and that modifications may be made without departing from the spirit and scope of the invention as set forth in the following claims.

We claim:

1. A plate-fin heat exchanger adapted to reduce thermal fatigue, including:
a cold fluid pathway running along a first axis;
a hot fluid pathway running along a second axis perpendicular to the first axis; and
at least one porous blocker bar running along the first axis, the porous blocker bar including a set of pores adapted to control flow along the hot fluid pathway and coupled to an inlet of the hot fluid pathway.

2. The plate-fin heat exchanger of claim 1, the cold fluid pathway including a first plurality of passages, each of the first plurality of passages including:
a plurality of cold bars running parallel to the first axis; and
at least one cold fin oriented to allow fluid to flow along the first axis.

3. The plate-fin heat exchanger of claim 2, the hot fluid pathway including a second plurality of passages, each of the second plurality of passages including:
a plurality of hot bars running parallel to the second axis; and
at least one hot fin oriented to allow fluid to flow along the second axis.

4. The plate-fin heat exchanger of claim 3, wherein the at least one porous blocker bar is coupled to at least two of the hot bars.

5. The plate-fin heat exchanger of claim 1, wherein each pore of the set of pores is cylindrically-shaped.

6. The plate-fin heat exchanger of claim 1, wherein the set of pores is oriented to allow flow along the second axis.

7. The plate-fin heat exchanger of claim 1, wherein the at least one porous blocker bar is adapted to be application-specific.

8. A porous blocker bar adapted for use in a plate-fin heat exchanger, the porous blocker bar including:
a front face;
a rear face; and
a plurality of pores, each of said pores spanning from the front face to the rear face.

9. The porous blocker bar of claim 8, wherein each of said pores has a cylindrical shape.

10. The porous blocker bar of claim 8, wherein the plurality of pores are substantially evenly spaced across the front face of the porous blocker bar.

11. The porous blocker bar of claim 8, wherein each pore of the plurality of pores has a uniform diameter.

12. The porous blocker bar of claim 8, wherein the height of the porous blocker bar is configured to match the height of a hot bar of the plate-fin heat exchanger and the width of a hot fin of the plate-fin heat exchanger.

13. The porous blocker bar of claim 8, wherein the plate-fin heat exchanger is adapted for use in high-temperature applications.

14. The porous blocker bar of claim 8, wherein each pore is parallel to an axis of hot flow through the heat exchanger.

15. A method of configuring a porous blocker bar for use in a plate-fin heat exchanger, the method including:
receiving dimensional parameters;
evaluating the received parameters;
calculating design parameters at least partly based on the received parameters; and
storing the calculated design parameters.

16. The method of claim 15, including receiving operating parameters.

17. The method of claim 16, wherein the operating parameters include a flow rate.

18. The method of claim 15, wherein the dimensional parameters include width, height, and depth of the porous blocker bar.

19. The method of claim 18, wherein the dimensional parameters include a predetermined value indicating the number of pores to be included in the porous blocker bar.

20. The method of claim 18, wherein the dimensional parameters include a spacing between the pores along a face of the porous blocker bar.
